(19) United States
(12) Patent Application Publication
(10) Pub. No.: US 2003/0041319 A1
(43) Pub. Date: Feb. 27, 2003

(54) Java bytecode instruction for retrieving string representations of java objects

(75) Inventor: Stepan Sokolov, Fremont, CA (US)

Correspondence Address: BEYER WEAVER & THOMAS LLP, P.O. BOX 778, BERKELEY, CA, 94704-0778, US

(73) Assignee: Sun Microsystems, Inc.

(21) Appl. No.: 09/939,315

(22) Filed: Aug. 24, 2001

(51) Int. Cl. G06F 9/45

(52) U.S. Cl. 717/148; 717/152

(57) ABSTRACT

Improved techniques for representing Java objects as strings are disclosed. An inventive Java Bytecode instruction suitable for execution by a Java virtual machine is disclosed. The inventive Java Bytecode instruction can be executed by a Java virtual machine to represent Java objects as strings. Moreover, Java objects can be represented as strings without invoking the Java “to_string” method which is conventionally used. This means that the costly overhead associated with repeatedly invoking Java method “to_string” is avoided. In other words, operations that are conventionally performed each time the Java “to_string” method is invoked need not be performed. As a result, the performance of virtual machines, especially those operating with limited resources (e.g., embedded systems) can be improved.

### BACKGROUND OF THE INVENTION

The present invention relates generally to Java programming environments, and more particularly, to techniques suitable for retrieving string representations of Java objects.

One of the goals of high level languages is to provide a portable programming environment such that the computer programs may easily be ported to another computer platform. High level languages such as “C” provide a level of abstraction from the underlying computer architecture and their success is well evidenced from the fact that most computer applications are now written in a high level language.

Portability has been taken to new heights with the advent of the World Wide Web (“the Web”) which is an interface protocol for the Internet which allows communication between diverse computer platforms through a graphical interface. Computers communicating over the Web are able to download and execute small applications called applets. Given that applets may be executed on a diverse assortment of computer platforms, the applets are typically executed by a Java virtual machine.

Recently, the Java programming environment has become quite popular. The Java programming language is a language that is designed to be portable enough to be executed on a wide range of computers ranging from small devices (e.g., pagers, cell phones and smart cards) up to supercomputers. Computer programs written in the Java programming language (and other languages) may be compiled into Java Bytecode instructions that are suitable for execution by a Java virtual machine implementation. The Java virtual machine is commonly implemented in software by means of an interpreter for the Java virtual machine instruction set but, in general, may be software, hardware, or both. A particular Java virtual machine implementation and corresponding support libraries together constitute a Java runtime environment.

Computer programs in the Java programming language are arranged in one or more classes or interfaces (referred to herein jointly as classes or class files). Such programs are generally platform, i.e., hardware and operating system, independent. As such, these computer programs may be executed without modification on any computer that is able to run an implementation of the Java runtime environment.

Object-oriented classes written in the Java programming language are compiled to a particular binary format called the “class file format.” The class file includes various components associated with a single class. These components can be, for example, methods and/or interfaces associated with the class. In addition, the class file format can include a significant amount of ancillary information that is associated with the class. The class file format (as well as the general operation of the Java virtual machine) is described in some detail in The Java Virtual Machine Specification, Second Edition, by Tim Lindholm and Frank Yellin, which is hereby incorporated herein by reference.

FIG. 1A shows a progression of a simple piece of a Java source code 101 through execution by an interpreter, the Java virtual machine. The Java source code 101 includes the classic Hello World program written in Java. The source code is then input into a Bytecode compiler 103 that compiles the source code into Bytecodes. The Bytecodes are virtual machine instructions as they will be executed by a software emulated computer. Typically, virtual machine instructions are generic (i.e., not designed for any specific microprocessor or computer architecture) but this is not required. The Bytecode compiler outputs a Java class file 105 that includes the Bytecodes for the Java program. The Java class file is input into a Java virtual machine 107. The Java virtual machine is an interpreter that decodes and executes the Bytecodes in the Java class file. The Java virtual machine is an interpreter, but is commonly referred to as a virtual machine as it emulates a microprocessor or computer architecture in software (e.g., the microprocessor or computer architecture may not exist in hardware).

FIG. 1B illustrates a simplified class file 100. As shown in FIG. 1B, the class file 100 includes a constant pool 102 portion, interfaces portion 104, fields portion 106, methods portion 108, and attributes portion 110. The methods portion 108 can include or have references to several Java methods associated with the Java class which is represented in the class file 100.

As is known in the art, often there is a need to represent a Java object as a string of characters. For example, in order to print an integer object, (or an integer field of an object) there is a need to represent the integer as a string of characters. Conventionally, a Java method, “Java.lang.object.to_string( )” is invoked by the virtual machine to represent objects (or fields associated with objects) as a string of characters. One problem with this approach is that there is an overhead associated with the invocation of a Java method. In other words, invocation of a Java method requires several operations to be performed. These operations include: locating the appropriate method to be invoked, creating a frame to be placed on the execution stack and restoring the previous frame on the stack.

Moreover, the cost associated with representing Java objects as strings is quite high because, during execution of a typical Java program, the to_string Java method has to be invoked time and time again. In other words, the operations needed to invoke a method have to be performed several times during the execution of a Java program. This, of course, can result in a grossly inefficient use of system resources. In some circumstances, particularly in systems with limited computing power and/or memory, this inefficient use of resources is a serious disadvantage.

In view of the foregoing, improved techniques for retrieving string representations of Java objects are needed.

### SUMMARY OF THE INVENTION

Broadly speaking, the invention relates to improved techniques for representing Java objects as strings. In accordance with one aspect of the invention, an inventive Java Bytecode instruction suitable for execution by a Java virtual machine is disclosed. As such, the inventive Java Bytecode instruction can be executed by a Java virtual machine to represent Java objects as strings. Moreover, the Java objects can be represented as strings without invoking the Java “to_string” method which is conventionally used. This means that the costly overhead associated with repeatedly invoking Java method “to_string” is avoided. In other words, operations that are conventionally performed each time the Java “to_string” method is invoked need not be performed. As a result, the performance of virtual machines, especially those operating with limited resources (e.g., embedded systems) can be improved.

The invention can be implemented in numerous ways, including as a method, an apparatus, a computer readable medium, and a database system. Several embodiments of the invention are discussed below.

As a Java Bytecode instruction suitable for execution by a Java virtual machine in the Java computing environment, one embodiment of the invention operates to retrieve a string representation associated with the Java object, thereby allowing the string representation to be determined without invoking a Java method.

As a Java virtual machine operating in a Java computing environment, one embodiment of the invention includes a Java virtual machine capable of determining a string representation associated with a Java object. The virtual machine determines the string representation of the Java object without invoking a Java “to_string” method.

As a method for retrieving a string representation for a Java object, one embodiment of the invention includes the acts of: receives an inventive Java Bytecode instruction in a stream of Java Bytecodes suitable for execution by a virtual machine operating in the Java computing environment. The Java Bytecode instruction operates to determine the string representation associated with the Java object; thereby allowing the string representation to be determined without invoking a Java method.

As a computer readable media including computer program code for retrieving a string representation for a Java object, one embodiment of the invention includes computer program code for receiving an inventive Java Bytecode instruction in a stream of Java Bytecodes suitable for execution by a virtual machine operating in the Java computing environment. The inventive Java Bytecode instruction operates to determine the string representation associated with the Java object, thereby allowing the string representation to be determined without invoking a Java method.

These and other aspects and advantages of the present invention will become more apparent when the detailed description below is read in conjunction with the accompanying drawings.

### BRIEF DESCRIPTION OF THE DRAWINGS

The present invention will be readily understood by the following detailed description in conjunction with the accompanying drawings, wherein like reference numerals designate like structural elements, and in which:

FIG. 1A shows a progression of a simple piece of a Java source code through execution by an interpreter, the Java virtual machine.

FIG. 1B illustrates a simplified class file.

FIGS. 2A-2B illustrate a Java computing environment in accordance with one embodiment of the invention.

FIG. 3 illustrates a method for representing Java objects as string in accordance with one embodiment of the invention.

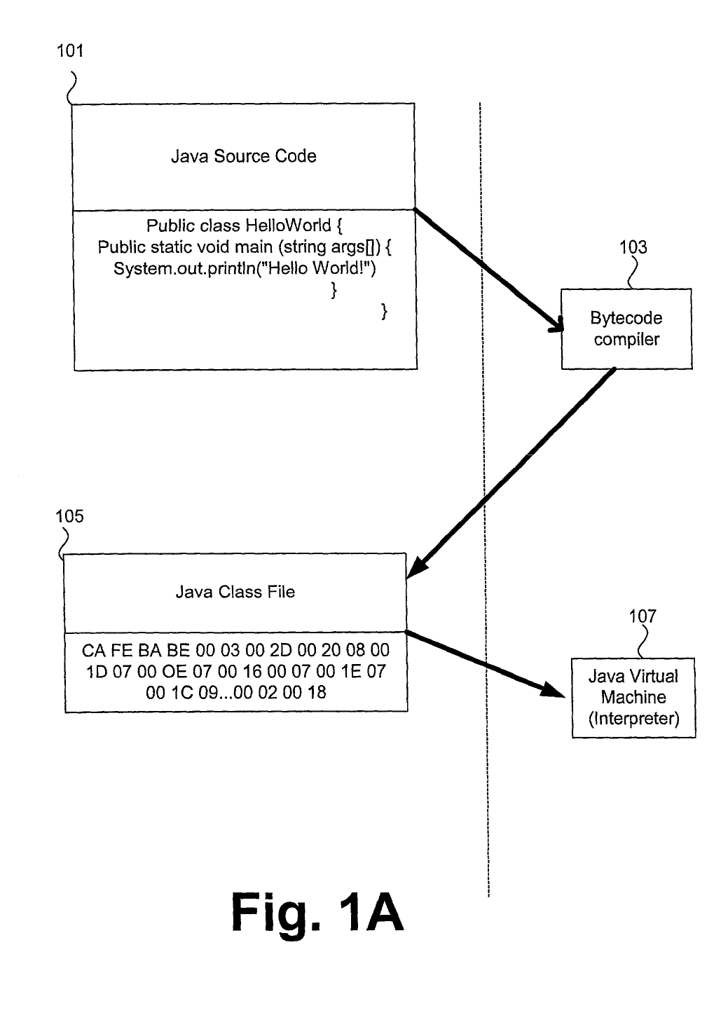

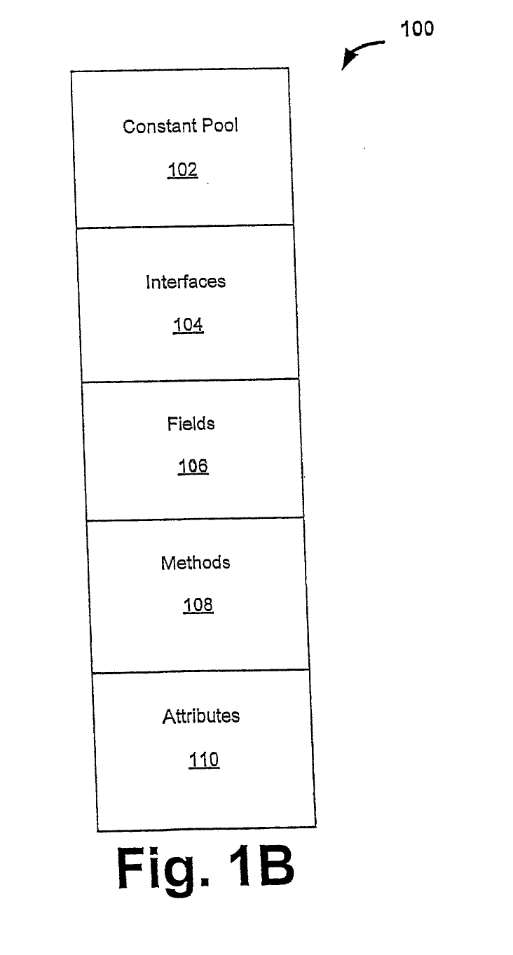

### DETAILED DESCRIPTION OF THE INVENTION

The present invention pertains to improved techniques for representing Java objects as strings. In accordance with one aspect of the invention, an inventive Java Bytecode instruction suitable for execution by a Java virtual machine is disclosed. As such, the inventive Java Bytecode instruction can be executed by a Java virtual machine to represent Java objects as strings. Moreover, the Java objects can be represented as strings without invoking the Java “to_string” method which is conventionally used. This means that the costly overhead associated with repeatedly invoking Java method “to_string” is avoided. In other words, operations that are conventionally performed each time the Java “to_string” method is invoked need not be performed. As a result, the performance of virtual machines, especially those operating with limited resources (e.g., embedded systems) can be improved.

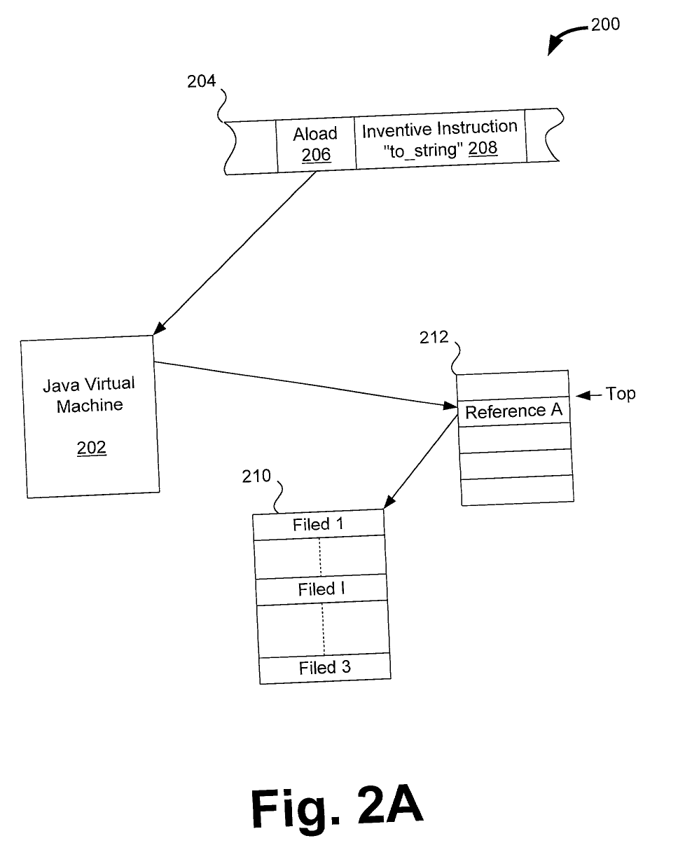

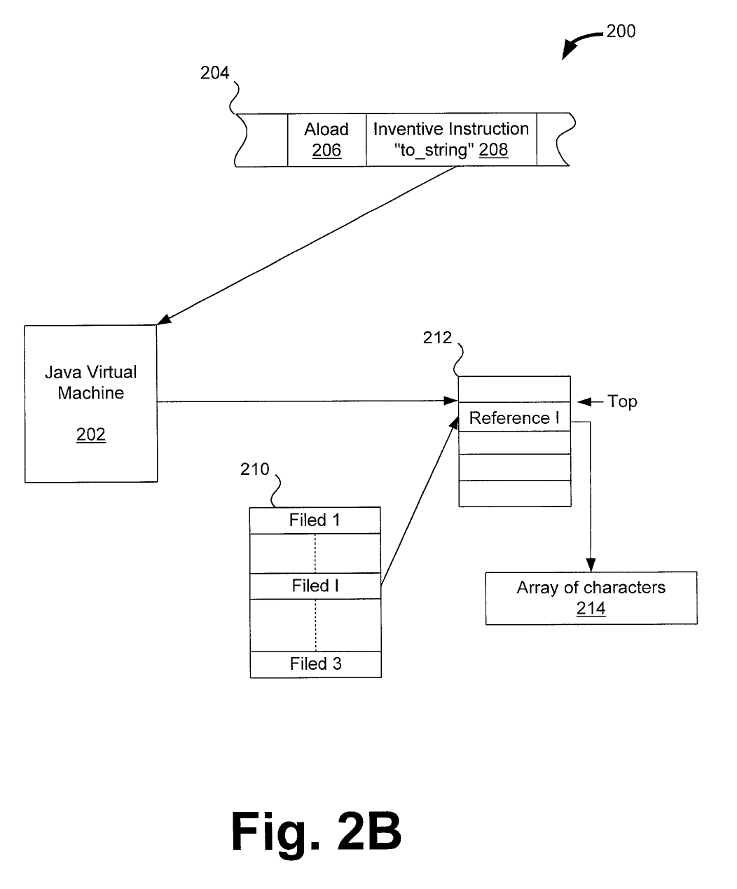

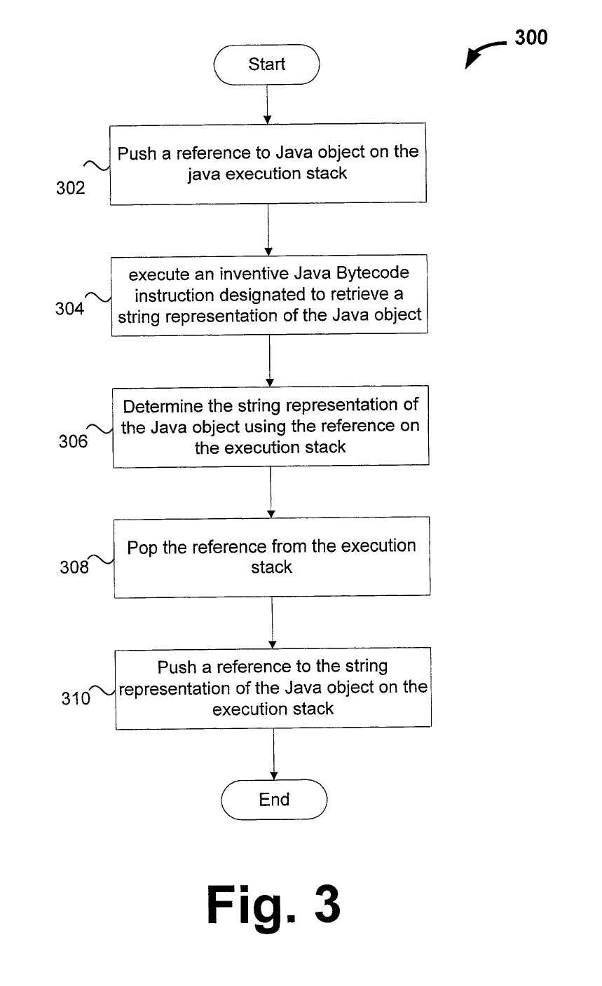

Embodiments of the invention are discussed below with reference to FIGS. 2A-3. However, those skilled in the art will readily appreciate that the detailed description given herein with respect to these figures is for explanatory purposes only as the invention extends beyond these limited embodiments.

FIGS. 2A-B illustrate a Java computing environment 200 including a virtual machine 202 in accordance with one embodiment of the invention. The virtual machine 202 can read a stream of Java Bytecodes 204 as input. The stream of Java Bytecodes 204 includes a Java “Aload” Bytecode instruction 206 and an inventive Java “to_string” Bytecode 208. The “Aload” Bytecode instruction 206 can be implemented as a Java Bytecode instruction which operates to push a reference A to a Java object 210 on an execution stack 212.

The inventive Java “to_string” Bytecode instruction 208 is a Java Bytecode instruction that has been specifically designated for representing Java objects as strings. As will be appreciated, the inventive Java “to_string” Bytecode instruction can be implemented as a new instruction that is added to the conventional Java Bytecode instruction set. This is possible because the conventional Java Bytecode instruction set does not typically use all the 256 possible values that can be coded by one byte (8 bits). As such, the inventive Java “to_string” Bytecode instruction set can be assigned a unique unassigned value which can be represented by 8 bits.

Referring now to FIG. 2B, the virtual machine 202 operates to receive the inventive Java Bytecode instruction 208. When the inventive Java “to_string” Bytecode instruction 208 is executed, the string representation of the Java object referenced by reference A (shown in FIG. 2A) is determined. Accordingly, the inventive Java Bytecode instruction “to_string” 208 can be used to represent Java objects as strings. Moreover, Java objects can be represented as strings without invoking a Java method. This means that costly overhead associated with invoking Java methods can be avoided. As a result, the performance of virtual machines, especially those operating with limited resources, can be improved.

FIG. 3 illustrates a method 300 for representing Java objects as string in accordance with one embodiment of the invention. The method 300 can be implemented by a virtual machine operating in a Java computing environment. Initially, at operation 302, a reference to a Java object is pushed on the execution stack. Next, at operation 304, an inventive Java Bytecode operation is executed. The inventive Java Bytecode operation is designated to represent the object as a string. Accordingly, at operation 306, the string representation of the Java object is determined using the reference to the Java object. Thereafter, at operation 308, the reference is popped from the stack. Finally, at operation 310, the string representation of the Java object is pushed on the top of the execution stack.

The many features and advantages of the present invention are apparent from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. In a Java computing environment, a Java Bytecode instruction suitable for execution by an inventive Java virtual machine in said Java computing environment, wherein said inventive Java Bytecode instruction operates to retrieve a string representation associated with said Java object, thereby allowing said string representation to be determined without invoking a Java method.

2. A Java Bytecode instruction as recited in claim 1, wherein said Java Bytecode instruction further operates to:
pop a reference to said Java Bytecode instruction from the top of an execution stack;
determine a string representation of a field associated with said Java object; and
push a reference to said string representation of said field on top of said execution stack.

3. A Java Bytecode instruction as recited in claim 1, wherein said Java Bytecode instruction is executed in an embedded system.

4. A Java virtual machine operating in a Java computing environment, said Java virtual machine capable of determining a string representation associated with a Java object, wherein said virtual machine determines said string representation of said Java object without invoking a Java “to_string” method.

5. Java virtual machine as recited in claim 4, wherein said Java virtual machine executes an inventive Java Bytecode instruction, said inventive Java Bytecode instruction operating to determine said string representation associated with said Java object; thereby allowing said string representation to be determined without invoking a Java method.

6. A Java virtual machine as recited in claim 5, wherein said virtual machine operates to:
pop a reference to said Java Bytecode instruction from the top of an execution stack;
determine a string representation of a field associated with said Java object; and
push a reference to said string representation of said field on top of said execution stack.

7. A Java virtual machine as recited in claim 5, wherein said Java virtual machine operates in an embedded system.

8. In a Java computing environment, a method of retrieving a string representation for a Java object, said method comprising:
receiving an inventive Java Bytecode instruction in a stream of Java Bytecodes suitable for execution by a virtual machine operating in said Java computing environment, and
wherein said inventive Java Bytecode instruction operates to determine said string representation associated with said Java object; thereby allowing said string representation to be determined without invoking a Java method.

9. A method as recited in claim 8, wherein said method further comprises:
popping a reference to a Java object from an execution stack
determining a string representation of a field associated with said Java object; and
pushing a reference to said string representation of said field on top of said execution stack.

10. A method as recited in claim 7, wherein said method further comprises: pushing a reference to said Java object on said execution stack.

11. A method as recited in claim 8, wherein said pushing of a reference to said Java object is performed by execution of a Java Aload execution.

12. A method as recited in claim 11, wherein said method is performed by a virtual machine.

13. A method as recited in claim 12, wherein said virtual machine is operating in an embedded system.

14. A computer readable media including computer program code for retrieving a string representation for a Java object, said computer readable media comprising:
computer program code for receiving an inventive Java Bytecode instruction in a stream of Java Bytecodes suitable for execution by a virtual machine operating in said Java computing environment, and
wherein said inventive Java Bytecode instruction operates to determine said string representation associated with said Java object; thereby allowing said string representation to be determined without invoking a Java method.

15. A computer readable media as recited in claim 14, wherein said computer readable media further comprises:
computer program code for popping a reference to a Java object from an execution stack;
computer program code for determining a string representation of a field associated with said Java object; and
computer program code for pushing a reference to said string representation of said field on top of said execution stack.

16. A computer readable media as recited in claim 15, wherein said computer readable media further comprises:
computer program code for pushing a reference to said Java object on said execution stack.

17. A computer readable media as recited in claim 16, wherein said computer program code for pushing said reference is performed by executing a Java Aload instruction.

18. A computer readable media as recited in claim 17, wherein said computer readable media is read by a Java virtual machine.

19. A computer readable media as recited in claim 18, wherein said virtual machine is operating in an embedded system.
